(19) United States
(12) Patent Application Publication
(10) Pub. No.: US 2016/0138932 A1
(43) Pub. Date: May 19, 2016

(54) SEARCH NEAR CURSOR

(71) Applicant: HONDA MOTOR CO., LTD, Tokyo (JP)

(72) Inventors: JUMPEI ICHINOKAWA, ROLLING HILLS ESTATE, CA (US); MAJA KURCISKA, SHERMAN OAKS, CA (US)

(21) Appl. No.: 14/540,759

(22) Filed: Nov. 13, 2014

(51) Int. Cl. G01C 21/36

(52) U.S. Cl. CPC G01C 21/367

(57) ABSTRACT

A navigation system has a display. A processor is coupled to the display. A memory is coupled to the processor. The memory stores program instructions that when executed by the processor, causes the processor to: display a graphical representation of a map on a display; display a first cursor showing a present location of a vehicle on the map; display a second cursor, the second cursor being movable by a user through a user interface of the navigation system to a desired location on the map; and display a line between the first cursor and the second cursor, the line indicating a straight line distance between the first cursor and the second cursor.

### FIELD

The present application generally relates to a vehicle navigation system, and, more particularly, to a vehicle navigation system with a scroll feature that may allow a user to move a cursor from a present location of where a vehicle is located to a desired location and to search for points of interest (POIs) located near the desired location.

### BACKGROUND

Many vehicles may now be equipped with navigations systems. Vehicle navigation systems may be used to search for and calculate a route from a current location of the vehicle to a desired destination. Typical vehicle navigation systems may be configured to allow a user to enter a name or address of the desired destination. The vehicle navigation system may calculate a route from a current location of the vehicle to the desired destination and provide turn-by-turn navigation directions to the driver via text, speech, or other communications avenues. The vehicle navigation may show a map in graphical format on a display. The map may show the present location of the vehicle as the vehicle moves along a highlighted path to the desired destination. The display may also show the textual directions.

Vehicle navigation systems may allow a user to perform a search for different types of points of interests (POIs) that may be located near the current location of the vehicle. The vehicle navigation system may allow the user to locate different POIs such as nearest gas station, restaurants, parks, shopping centers and other destination types and then select one of the POIs. The vehicle navigation system may then calculate a preferred route to the selected POI.

In present vehicle navigation systems, the vehicle location may be represented as a cursor and located in a center area of the display. In general, one cannot move the location of the cursor, as the cursor represents the current location of the vehicle. Even when the vehicle is moving, the cursor generally stays in the middle of the display and the graphical representation of the map continuously updates as the vehicle moves. Since one cannot move the cursor, present vehicle navigation systems generally do not allow one to search for POIs that may be located away from or remote from the current location of the vehicle. For example, if a driver wanted to look for restaurants located on another side of the city, remote from the present location of the vehicle, present vehicle navigation systems generally do not functionality.

Therefore, it would be desirable to provide a system and method that overcome the above identified concerns, as well as additional challenges which will become apparent from the disclosure set forth below.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a navigation system is disclosed. The navigation system has a display. A processor is coupled to the display. A memory is coupled to the processor. The memory stores program instructions that when executed by the processor, causes the processor to: display a graphical representation of a map on a display; display a first cursor showing a present location of a vehicle on the map; display a second cursor, the second cursor being movable by a user through a user interface of the navigation system to a desired location on the map; and display a line between the first cursor and the second cursor, the line indicating a straight line distance between the first cursor and the second cursor.

In accordance with one aspect of the present application, a method of displaying a map on a display of a navigation system is disclosed. The method comprises: determining a current location of the navigation system; displaying a map showing a first cursor showing the current location; displaying a second cursor on the map; moving the second cursor to a user selected position; and displaying a line between the first cursor and the second cursor indicating a straight line distance between the first cursor and the second cursor.

In accordance with one aspect of the present application, a navigation system is disclosed. The navigation system has a display. A processor is coupled to the display. A memory is coupled to the processor. The memory stores program instructions that when executed by the processor, causes the processor to: display a graphical representation of a map on a display; display a first cursor showing a present location of a vehicle on the map; display a second cursor, the second cursor being movable by a user through a user interface of the navigation system to a desired location on the map; remove overlay data on the map when the second cursor is moved by the user; display a line between the first cursor and the second cursor, the line indicating a straight line distance between the first cursor and the second cursor; display one of an address or polygon name where the second cursor is located; and display a menu list when the second cursor is set on the desired location, the menu list allowing the user to display points of interest (POIs) located near the second cursor, set a location of the second cursor as a destination, view a route on the map from the first cursor to the second cursor, and save a location of the second cursor as a “Favorite Place”.

### BRIEF DESCRIPTION OF THE DRAWINGS

Embodiments of the disclosure will become more fully understood from the detailed description and the accompanying drawings, wherein:

FIG. 1 is a side view of a vehicle implementing an exemplary navigation system having a scroll feature to move a cursor to a desired point and to search for points of interest near the desired point in accordance with one aspect of the present application;

FIG. 2 is a simplified functional block diagram of the exemplary navigation system depicted in FIG. 1 in accordance with one aspect of the present application;

FIG. 3 shows one embodiment of a screen view generated by the exemplary navigation system depicted in FIG. 1 with a Desired Location (DL) cursor aligned with a Vehicle Position (VP) cursor in accordance with one aspect of the present application;

FIG. 4 shows one embodiment of an illustrative screen view generated by the exemplary navigation system depicted in FIG. 1 with the DL cursor moved to a user selected position in accordance with one aspect of the present application;

FIG. 5 shows one embodiment of an illustrative menu screen generated by the exemplary navigation system depicted in FIG. 1 when the DL cursor is set at the user selected position in accordance with one aspect of the present application; and

FIG. 6 is an exemplary flowchart depicting an illustrative method to move a cursor from a present location of where a vehicle is located to a desired location according to one aspect of the present application in accordance with one aspect of the present application.

### DESCRIPTION OF THE INVENTION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

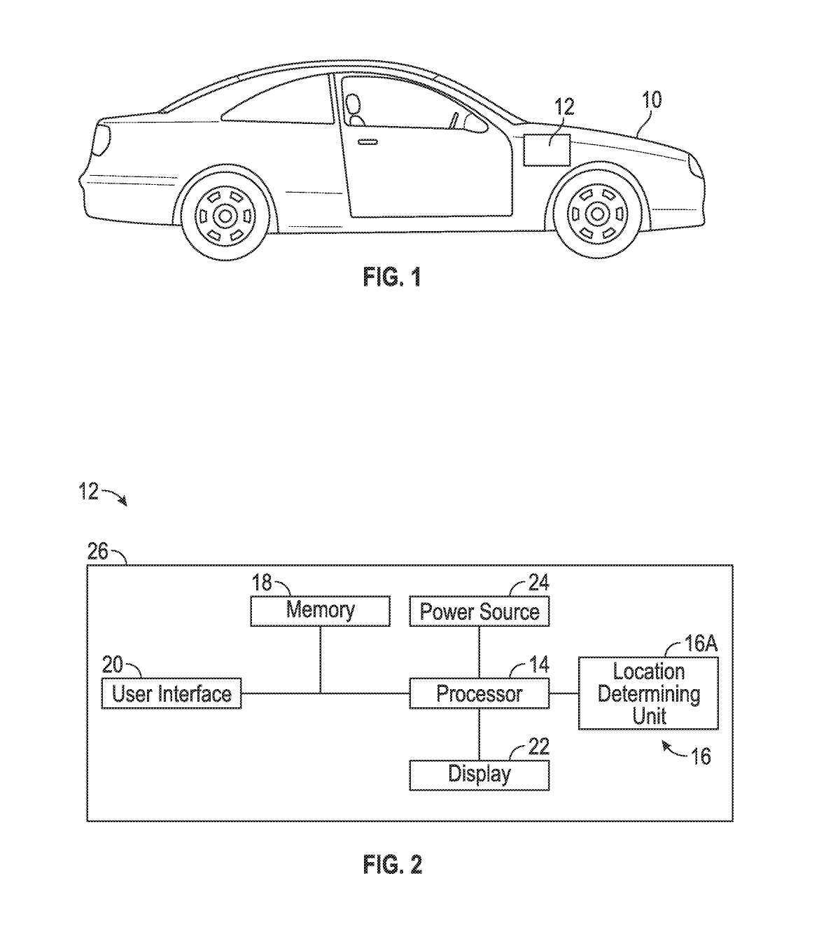

Referring to FIG. 1, an exemplary vehicle 10 may be seen. The vehicle 10 may be equipped with a navigation system 12. The navigation system 12 may be used to provide directional guidance from a present location of the vehicle 10 to a desired location. The navigation system 12 may be configured to allow a user to move a location of a cursor on a display of the navigation system 12. The user may move the location of the cursor from a current vehicle position (VP) to a desired location (DL). By moving the cursor, the system 12 may allow one to search for POIs at the DL which may be away from or remote from the current location of the vehicle.

Referring now to FIG. 2, in accordance with one embodiment, the navigation system 12 may have a processor 14, a location determining unit 16, a memory 18, a user interface 20, a display 22 and a power source 24. Each of the above mentioned components of the navigation system 12 may be placed within a housing 26. The processor 14 may be coupled to the user interface 20, location determining unit 16, memory 18, and display 22, through wired or wireless connections to enable information to be exchanged between the various components. All or some of the components of the navigation system 12 may be powered via the power source 24.

The processor 14 may be used to control the various functions of the navigation system 12. The processor 14 may be implemented in hardware, software or a combination thereof. The processor 14 may store a computer program or other programming instructions associated with the memory 18 to control the operation of navigation system 12. The data structures and code within the software in which the present disclosure may be implemented, may be stored on a non-transitory computer-readable storage. The non-transitory computer-readable storage may be any device or medium that may store code and/or data for use by a computer system. The non-transitory computer-readable storage medium may include, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. The processor 14 may comprise various computing elements, such as integrated circuits, microcontrollers, microprocessors, programmable logic devices, etc, alone or in combination to perform the operations described herein.

When the navigation system 12 is active, the processor 14 may determine a current location of the vehicle 10 having the navigation system 12. The processor 14 may receive location data from the location determining unit 16. In accordance with one embodiment, the location determining unit 16 may be a Global Positioning Satellite (GPS) device 16A. The GPS device 16A may calculate the current location of the vehicle 10 by timing signals sent by GPS satellites. Each GPS satellite may continually transmits message signals that may include the time the message was transmitted and GPS satellite position at the time the message signal was transmission. The GPS device 16A may use the message signals received to determine a transit time of each message signal and computes the distance to each GPS satellite. These distances and satellite locations may be used to compute the location of the GPS device 16A and thus the present location of the vehicle 10. The above is given as one example. The processor 14 may determine a current location of the vehicle 10 in other manners.

The memory 18 may be coupled to the processor 14 as well as other components of the navigation system 12. The memory 18 may be used to store various data utilized by the processor 14 and or other components of the navigation system 12. The memory 18 may include removable and non-removable memory elements such as RAM, ROM, flash, magnetic, optical, and/or other conventional memory elements. The above listing is given as an example and should not be seen in a limiting manner.

The memory 18 may be used to store programming data for instructing the processor 14 or other components of the navigation system 12 to perform certain steps as will be described below. The memory 18 may also store various geographical representations of maps and navigation data, as well as data related to POIs and other related data.

The user interface 20 may be coupled to the processor 14 as well as other components of the navigation system 12. The user interface 20 may be used to enter information into the navigation system 12. The user interface 20 may be buttons, switches, keyboard, trackball, scroll wheel or similar device used to enter data. In accordance with one embodiment, the display unit 22 may show an alphanumeric keyboard or other input mechanisms and the user interface 20 may be used to select and enter a desired letter, number and/or other input command. Alternatively, the display unit 22 may be a touch screen display thereby functioning as a display unit 22 and the user interface 20.

The display 22 may be coupled to the processor 14 as well as other components of the navigation system 12. The display 22 may be used to show graphical representations of maps, routes, POIs, and other data as will be detailed below. The display 22 may be used to show an alphanumeric keyboard and/or other input mechanism to be used with or as the user interface 20. The display 22 may be a Cathode Ray Tube (CRT), Liquid Crystal Display (LCD) or display types.

The power source 24 may be provided to supply power to the various components of the navigation system 12. The power source 24 may be used to directly or indirectly power the processor 14, the location determining unit 16, memory 18, user interface 20 and/or display 22. The power source 24 may be batteries, an adapter for running off of power supplied by the vehicle 10 or power supply devices.

Based on the current location identified, the processor 14 may display a graphical representation of a map showing the current location of the vehicle 10 on the display unit 22. The processor 14 may obtain map data from the memory 18. Alternatively, the processor 14 may download map data via the location determining unit 16 (i.e., the GPS device 16A). The graphical representation of the map shown on the display 22 may be a two dimensional representation, a three dimensional representation, a satellite image representation, or other graphical representations.

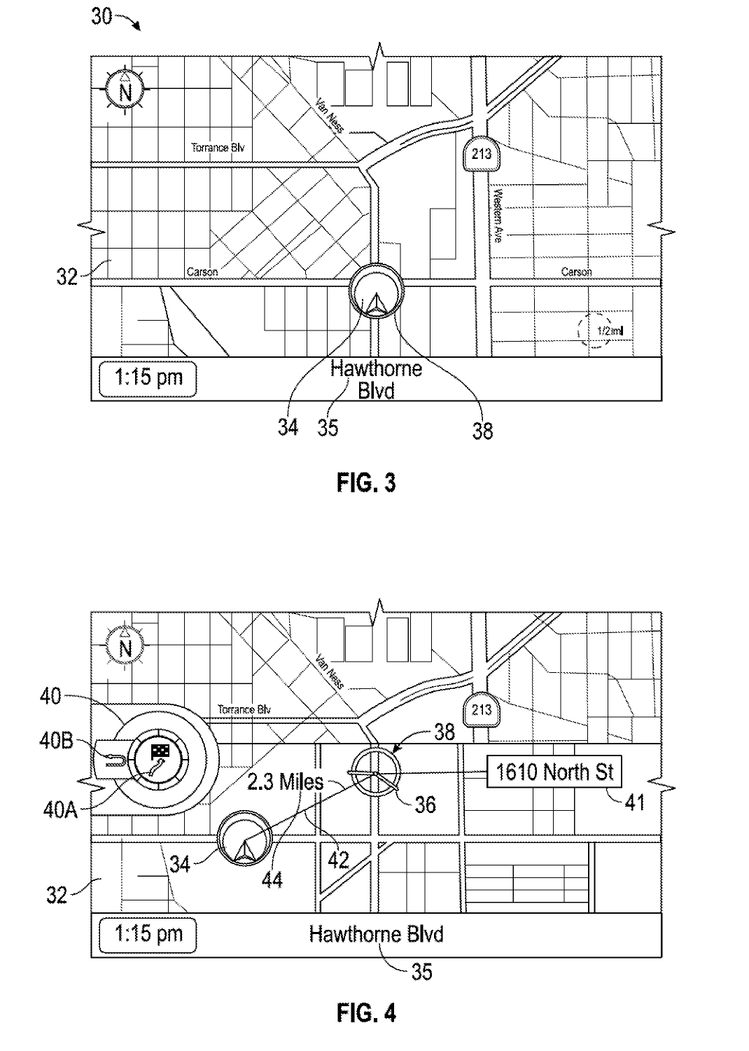

Referring now to FIGS. 1-6, operation of the navigation system 12 may be described. When the navigation system 12 is activated, the navigation system 12 may identify a current location of the vehicle 10. An initial screen view 30 may be generated as shown in FIG. 3. In general, the initial screen view 30 may show a graphical representation of a map 32. A vehicle position (VP) cursor 34 may be shown on the map 32. The VP cursor 34 may be a graphical representation of the vehicle 12 indicating a present location of the vehicle 10 on the map 32. Data 35 may be shown on the screen view 30 indicating a current street name where the VP cursor 34 is located. Other data such as a current time or a compass indicator may be shown on the screen view 30. If a route has been calculated, a preferred route may be highlighted. The navigation system 12 may be dynamic such that as the vehicle 10 moves, the graphical representation of the map 32 and the position of the VP cursor 34 on the map 32 may be updated.

In general, in prior art navigation systems, a user may not move the location of the VP cursor 34 to a location on the map 32 that is not the current location of the vehicle 12. In prior art navigation systems, the VP cursor 34 may show the current location of the vehicle 12 on the map 32. Thus, prior art navigation systems have limited functionality as to allow the user to move the VP cursor 34 to a different desired location 36 on the map 32 and to show different POIs located near the desired location 36.

When the navigation system 12 is activated, the VP cursor 34 may be located in a center area of the map 32 as shown in FIG. 3. The navigation system 12 may be configured to allow the user to select a desired location 36 on the map 32 and to show POIs located near the desired location. To select a desired location 36, the user may use the user interface 20. The user interface 20 may have a button, switch or other input device which may be used to activate the ability for the navigation system 10 to have the user select the desired location 36.

When the navigation system 10 has been activated to allow the user to select the desired location 36, a desired location (DL) cursor 38 may appear. The DL cursor 38 may first appear aligned with the VP cursor 34 as shown in FIG. 3. However, the DL cursor 38 may be move to any location on the map 32. The user may move/scroll the DL cursor 38 in any direction on the map 32. To move the DL cursor 38, the user may use the user interface 20. The user interface 20 may have a button, switch or other input device which may be used to move/scroll the DL cursor 38. In the embodiment shown in FIG. 4, a scroll button 40 may appear on the display 22. The scroll button 40 may be a touch screen button on the display 22 which may allow the user to move the DL cursor 38 in any direction on the map 32. In accordance with one embodiment, the scroll button 40 is a touch screen 8-way scroll button.

When moving the DL cursor 38, DL cursor 38 may remain centered on the map 32 as shown in FIG. 4. All overlays such landmark indicators, directional indicator, and other information may disappear from the display 22. When the user moves the DL cursor 38 to the desired point 36 on the map 32, the user may press a menu button on the user interface 20 corresponding to the DL cursor 38. In accordance with the embodiment shown in FIG. 4, the menu button 40A may be a center area on the scroll button 40 that appears on the display 22. By pressing the menu button 40A, the user may select the current location where the DL cursor 38 is located as the desired location 36. An address or polygon name 41 corresponding to a location where the DL cursor 38 is located may appear on the screen view 30. If the DL cursor 38 is positioned on an empty space of the map 32, then the closest road link or polygon name may be displayed.

A straight line 42 may be shown from the current vehicle position identified by the VP cursor 34 to the DL cursor 38. The straight line 42 may show the straight line distance between the current vehicle position identified by the VP cursor 34 and the DL cursor 38. Indicia or other labels 44 may appear proximate the straight line 42 showing the straight line distance between the current vehicle position identified by the VP cursor 34 and the DL cursor 38.

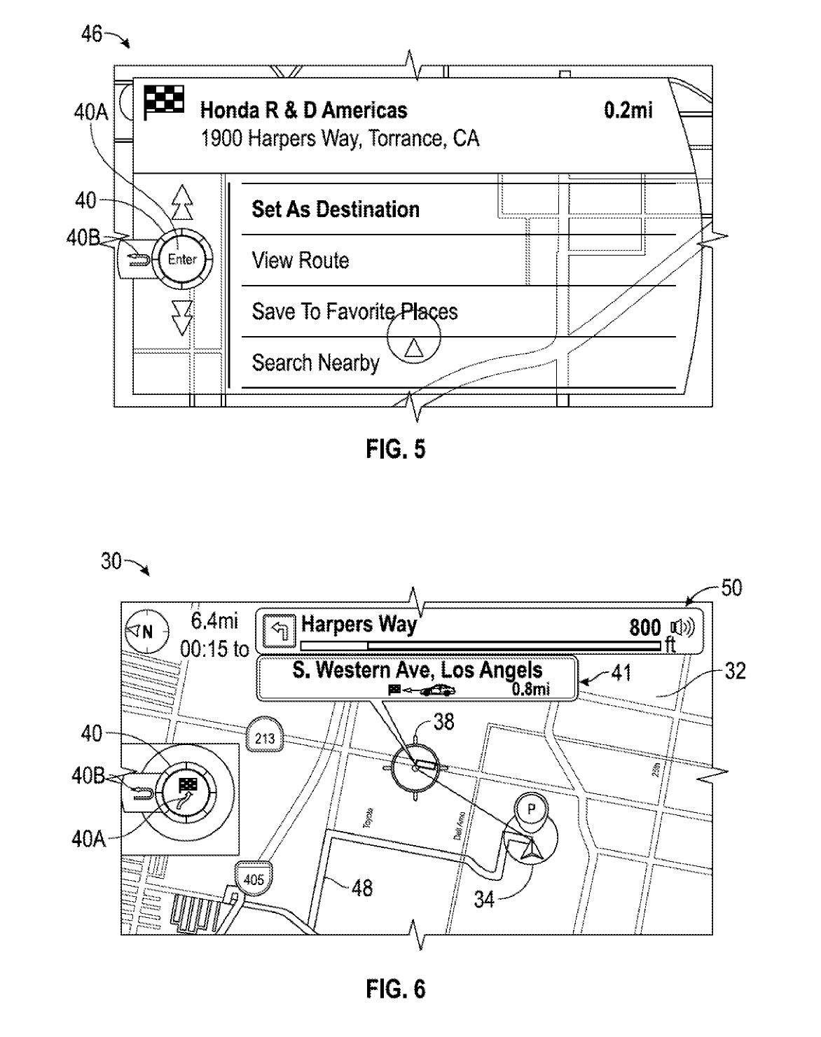

A menu list 46 may be shown on the display 22 as shown in FIG. 5. The menu list 46 may show a plurality of options for the user. For example, using the menu list 46, the user may set the current location of the DL cursor 38 as the destination; view a route along roadways shown on the map 32 from the current vehicle position identified by the VP cursor 34 to the DL cursor 38; save the current location where the DL cursor 38 as a “Favorite Place”; and display points of interest (POIs) located near the current location where the DL cursor 38 is located. The above is given as an example. The menu list 46 may provide other options than those listed above.

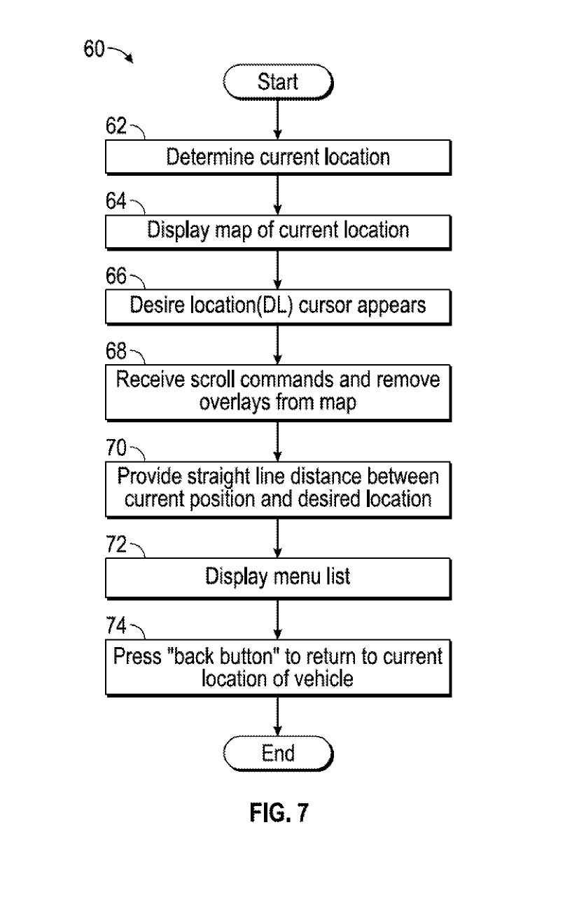

Referring to FIG. 6, when using the navigation system 12 (FIG. 2), if a destination has been entered, a preferred route 48 may be calculated and highlighted. Textual directions 50 may be displayed on the screen view 30. If the user wishes to scroll/move the DL cursor 38 while the preferred route 48 is highlighted and the textual directions 50 displayed, a select few of the textual directions 50 may be displayed. As shown in FIG. 6, the top two textual directions may be displayed.

If at any time the user wishes to return back to viewing only the current VP, the user may press a back button on the user interface 20. In accordance with the embodiment, the back button 40B may be a button located proximate the scroll button 40 that appears on the display 22. By pressing the back button 40B, the user may go to the screen depicted in FIG. 3 showing the current location of the vehicle 10 as identified by the VP cursor 34. If a preferred route 48 has been calculated and highlighted, the preferred route 48 may be shown. All the textual directions 50 may be displayed on the screen view 30 if a preferred route 48 has been calculated and highlighted.

Referring now to FIGS. 1-7 operation of the navigation system 12 may be disclosed. The method starts with a determination of a current location of the vehicle 10 as shown in block 62. A map 32 may be displayed showing the current location of the vehicle 12 as shown in block 64. If a destination location has been entered via the user interface 20, a preferred route 48 may be calculated and shown on the map 32. If a user wishes to select a desired location 36 on the map 32, a user may enter a command for a desired location (DL) cursor 38 to appear as shown in block 66. In response to the user scrolling the DL cursor 38, overlays on the map may be removed as shown in block 68. When a user moves the DL cursor 38 to a desired location 36, a straight line distance between the DL cursor 38 and the current location of the vehicle 12 may be displayed as shown in block 70. A menu list 46 may be shown on the display 22 as shown in block 72. The menu list 46 may show a plurality of options for the user. For example, using the menu list 46, the user may set the current location of the DL cursor 38 as the destination; view a route along roadways shown on the map 32 from the current vehicle position identified by the VP cursor 34 to the DL cursor 38; save the current location where the DL cursor 38 as a “Favorite Place”; and display points of interest (POIs) located near the current location where the DL cursor 38 is located. The above is given as an example. The menu list 46 may provide other options than those listed above. If the user wishes to return back to viewing the current location of the vehicle 10, the user may press a back button. By pressing the back button, the user may go to the screen showing the current location of the vehicle 10 as identified by the VP cursor 34 as shown in block 74. If a preferred route 48 has been calculated and highlighted, the preferred route 48 may be shown. All the textual directions 50 may be displayed on the screen view 30.

The foregoing description is illustrative of particular embodiments of the invention, but is not meant to be a limitation upon the practice thereof. The following claims, including all equivalents thereof, are intended to define the scope of the invention.

1. A navigation system comprising:
a display;
a processor coupled to the display; and
a memory coupled to the processor, the memory storing program instructions that when executed by the processor, causes the processor to:
display a graphical representation of a map on a display;
display a first cursor showing a present location of a vehicle on the map;
display a second cursor;
move the second cursor by a user through a user interface of the navigation system to a desired location on the map; and
display a line between the first cursor and the second cursor, the line indicating a straight line distance between the first cursor and the second cursor moved to the desired location on the map.

2. The navigation system, in accordance with claim 1, wherein the memory storing program instructions that when executed by the processor, causes the processor to display a menu list when the second cursor is set on the desired location, the menu list displaying a command to display points of interest (POIs) located near the desired location.

3. The navigation system, in accordance with claim 2, wherein the menu list displays a command to set a location of the second cursor as a destination.

4. The navigation system, in accordance with claim 2, wherein the menu list allows the user to view a route on the map from the first cursor to the second cursor.

5. The navigation system, in accordance with claim 2, wherein the menu list displays a command to save a location of the second cursor as a “Favorite Place”.

6. The navigation system, in accordance with claim 1, wherein the memory storing program instructions that when executed by the processor, causes the processor to remove overlay data on the map when the second cursor is moved by the user.

7. The navigation system of claim 1, wherein the memory storing program instructions that when executed by the processor, causes the processor to move the second cursor to a nearest road link or polygon name when the second cursor is positioned on an empty space on the map.

8. The navigation system of claim 1, wherein the memory storing program instructions that when executed by the processor, causes the processor to display one of an address or polygon name where the second cursor is located.

9. The navigation system of claim 1, wherein the memory storing program instructions that when executed by the processor, causes the processor to:
display a route from the present location to a destination;
display textual directions from the present location to the destination; and
display selected textual directions when the second cursor is being moved by the user.

10. The navigation system of claim 1, wherein the memory storing program instructions that when executed by the processor, causes the processor to display the map and the first cursor when a return command is entered in the user interface.

11. The navigation system of claim 1, wherein the memory storing program instructions that when executed by the processor, causes the processor to display the second cursor aligned with the first cursor prior to the user moving the second cursor to the desired location on the map.

12. A method of displaying a map on a display of a navigation system comprising:
determining a current location of the navigation system;
displaying a map showing a first cursor indicating the current location;
displaying a second cursor on the map aligned with the first cursor;
moving the second cursor to a desired user selected position; and
displaying a line between the first cursor and the second cursor indicating a straight line distance between the first cursor and the second cursor moved to the desired location on the map.

13. The method of claim 12, further comprising displaying one of an address or polygon name where the second cursor is located.

14. The method of claim 12, comprising displaying a menu list when the second cursor is set, the menu list displaying a command to display points of interest (POIs) located near the second cursor.

15. The method of claim 14, wherein the menu list displays a command to set a location of the second cursor as a destination, view a route on the map from the first cursor to the second cursor, and save a location of the second cursor as a “Favorite Place”.

16. The method of claim 12, comprising removing overlay data on the map when the second cursor is being moved by the user.

17. The method of claim 12, comprising moving the second cursor to a nearest road link or polygon name when the second cursor is positioned on an empty space on the map.

18. The method of claim 12, comprising:
displaying a route from the present location to a destination;
displaying textual directions from the present location to the destination; and
displaying selected textual directions when the second cursor is being moved by the user.

19. A navigation system comprising:
a display;
a processor coupled to the display; and
a memory coupled to the processor, the memory storing program instructions that when executed by the processor, causes the processor to:
display a graphical representation of a map on a display;
display a first cursor showing a present location of a vehicle on the map;
display a second cursor;
move the second cursor by a user through a user interface of the navigation system to a desired location on the map;
remove overlay data on the map when the second cursor is being moved by the user;
display a line between the first cursor and the second cursor, the line indicating a straight line distance between the first cursor and the second cursor moved to the desired location on the map;
display one of an address or polygon name where the second cursor is located; and
display a menu list when the second cursor is set on the desired location, the menu list displaying commands to display points of interest (POIs) located near the second cursor, set a location of the second cursor as a destination, view a route on the map from the first cursor to the second cursor, and save a location of the second cursor as a “Favorite Place”.

20. The navigation system of claim 1, wherein the memory storing program instructions that when executed by the processor, causes the processor to move the second cursor to a nearest road link or polygon name when the second cursor is positioned on an empty space on the map.
